(19) United States
(12) Patent Application Publication
(10) Pub. No.: US 2024/0202875 A1
(43) Pub. Date: Jun. 20, 2024

(54) METHOD OF DETECTING WAFER DEFECTS BASED ON SINGULARLY VALUABLE DECOMPOSITION

(71) Applicant: United Semiconductor (Xiamen) Co., Ltd., Xiamen (CN)

(72) Inventors: Yi Han Ni, Fuqing City (CN); Xiongwu He, Xiamen (CN); Yuan-Chi Pai, Xiamen (CN); Wen Yi Tan, Xiamen (CN)

(73) Assignee: United Semiconductor (Xiamen) Co., Ltd., Xiamen (CN)

(21) Appl. No.: 18/144,251

(22) Filed: May 8, 2023

(30) Foreign Application Priority Data
Apr. 4, 2023 (CN) 202310352417.3

(51) Int. Cl. G06T 5/40; G06T 3/40; G06T 5/00; G06T 5/50; G06T 7/00

(52) U.S. Cl. CPC G06T 5/40; G06T 3/40; G06T 5/002; G06T 5/50; G06T 7/0004; G06T 2207/20021; G06T 2207/30148; G06T 2207/30168

(57) ABSTRACT

A method of detecting wafer defects based on singularly valuable decomposition is provided in the present invention, including steps of input a wafer image, performing a preprocess to the wafer image through histogram equalization to obtain a preprocessed image, performing singularly valuable decomposition to the preprocessed image, performing defect magnification to the decomposed wafer image, reconstruct the magnified wafer image to obtain a defect saliency image, denoising the defect saliency image, and detecting defects in the denoised wafer image.

### BACKGROUND OF THE INVENTION

### 1. Field of the Invention

The present invention relates generally to a method of detecting wafer defects, and more specifically, to a method of detecting wafer defects based on singularly valuable decomposition.

### 2. Description of the Prior Art

Semiconductor wafer consists of multiple layer structures, wherein complicated and precise process steps like material deposition, photoresist coating, etching and/or ion implantation are performed in every layer to form IC patterns. Defects must be detected and inspected in present layer before continuing following process. Common wafer defect may include scratch, abnormal exposure, particle contamination, hot spot, bevel defect, etc., or other various defects impacting the electrical property and performance of final chip or product. If these defects can't be detected immediately after the process of present layer, they can only be aware in final test, which may waste precious cycle time and resource.

The most intuitive way to detect wafer defects is to inspect the wafer surface through visual method, for example human vision inspection like after etching inspection (AEI) or machine vision inspection like KLA defect scanning. Wafer defects may be formed at any position on the wafer surface, and are usually mixed in complicated IC background of wafer levels formed in previous processes. Under the circumstance, it is very difficult to detect and recognize these defects even using high-accuracy machine vision method. It is still necessary for those of skilled in the art to improve current available method for detecting wafer defects, in order to improve the accuracy and reliability of defect detection.

### SUMMARY OF THE INVENTION

In the light of the aforementioned circumstance, the present invention hereby provides a method of detecting wafer defects, with feature of dividing the wafer image into low-rank semiconductor patterns and sparse defect patterns, thereby significantly improving defect recognition and detectability.

The objective of present invention is to provide a method of detecting wafer defects based on singularly valuable decomposition, including steps of inputting a wafer image, performing a preprocess to the wafer image through histogram equalization to obtain a preprocessed image, performing singularly valuable decomposition to the preprocessed image, performing defect magnification to the wafer image decomposed by the singularly valuable decomposition, reconstructing the wafer image magnified by the defect magnification to obtain a defect saliency image, denoising the defect saliency image, and detecting defects in the denoised wafer image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of detecting wafer defects in accordance with the preferred embodiment of present invention;

FIG. 2 is a schematic diagram of dividing a wafer image through singularly valuable decomposition in accordance with the preferred embodiment of present invention;

FIG. 3 is a schematic diagram illustrating a result of a m×n matrix decomposed through singularly valuable decomposition; and

FIG. 4 is an image illustrating the evolution of a wafer image in the process of defect detection in accordance with the preferred embodiment of present invention.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

Preferably, one or more of such embodiments of the present invention are embodied in a computer implemented program or control system. The computer for executing this kind of program or control system may be a general purpose computer architecture, wherein user may enter commands for executing the computer-implemented methods of the present invention through user interfaces like displayer, keyboard or mouse, or these methods may be executed automatically through automatic control system. The processor in the computer may access, calculate and process the computer readable code and data from the memory of computer. High capacity storage device like disk drive may provide program code or data relevant to the computer-implemented methods of the present invention and load them into the memory. Input/output device may provide connectivity for transmitting data to various equipment, ex. networks, modems, printers or inspection tools.

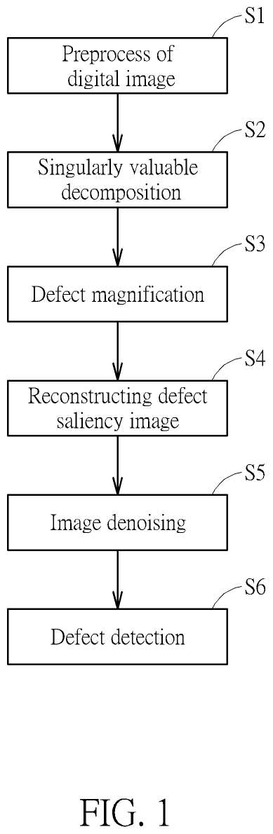

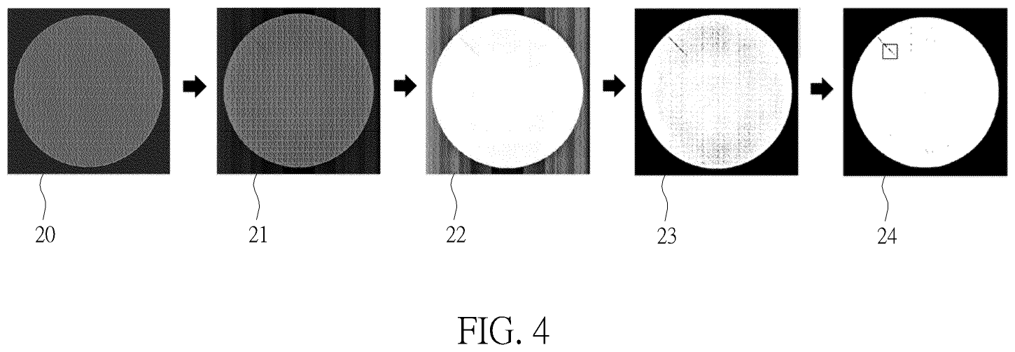

Please refer first to FIG. 1, which is a flow chart of detecting wafer defects in accordance with the preferred embodiment of present invention. First, at the beginning of the flow, provide a wafer image as a target for the method of detecting wafer defects of the present invention, as the image 20 shown in FIG. 4. The wafer image may be a surface image of a wafer immediately after any semiconductor process, for example a wafer image after an etching process, which may be in format of analog or digital color image in the embodiment of present invention. Image 20 may include normal semiconductor patterns in present layer and pre-layers of the wafer, ex. IC patterns or photoresist patterns formed in previous processes, wherein abnormal patterns like wafer defects may also be included in the image, ex. unapparent scratch in upper left of the image 20, that is the defect feature to be detected by the method of detecting wafer defects of the present invention.

After the wafer image 20 to be detected is provided, in step S1, perform a preprocess to the image 20, which may include steps of inputting the image 20 into a computer system and converting it into digital, grayscale image easy to be processed by computer. Specifically, digital, grayscale image 20 may be considered to be a matrix composed of multiple pixels, each pixel has its corresponding pixel value, ex. 256 different intensities of grayscale value ranged from 0 to 255, wherein pure black is defined as 0 and pure white is defined as 255. Subsequently, the pixel number of each grayscale value in the image matrix may be counted through histogram equalization to create a histogram of image grayscale value. Through adjusting the cumulative distribution function (CDF) in the histogram, the area having high pixel value may be distributed to surrounding areas to spread out the range of pixel intensities, make the image information more evenly in 0-255 grayscale distribution, so that global contrast of the image may be significantly increased to improve subjective vision of the image and facilitate the process of following image processing.

Furthermore, the image after histogram equalization may be further normalized in this step to normalize the equalized pixel values and make them ranged between 0 and 1, ex. the percentage of the pixel values divided by a sum of all pixel values in the image matrix, to facilitate following image processing. The wafer image processed by the aforementioned histogram equalization and normalization is shown as the image 21 in FIG. 4. It can be seen in the figure that the global contrast of processed wafer image is significantly increased.

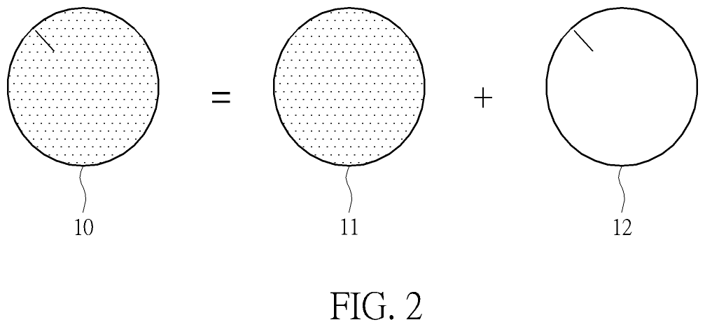

After the aforementioned preprocess of wafer image is completed, in step S2, perform a singularly valuable decomposition to the preprocessed image 21. Please refer to FIG. 2, which is a schematic diagram of dividing a wafer image through singularly valuable decomposition in accordance with the preferred embodiment of present invention. With respect to a wafer image 10, the included patterns may be composed of normal, low-rank part 11, ex. regular semiconductor patterns formed in present layer and pre-layers, and abnormal sparse part 12, ex. wafer defects like scratches to be detected, wherein the rank denotes the information like richness, redundancy and noise of the image. Lower rank denotes the redundancy of the image is higher and the dependency between the rows in image matrix is also higher, such as the part of regular semiconductor patterns. On the other hand, higher rank denotes the richness of the image is higher and the dependency between the rows in image matrix is lower, such as the part of abnormal wafer defects, which is independent pattern part on entire wafer with no correlation to normal semiconductor patterns and it is also the target part to be detected in the present invention. Since the wafer image is provided with structural information, it is suitable to be presented by using low-rank matrix to denote the matrix of pixel values of the aforementioned equalized and normalized image 21 and decompose and/or reduce abnormal information therein through massive included redundant information.

In step S2, the matrix of pixel values of the aforementioned equalized and normalized image 21 will be decomposed through singularly valuable decomposition, which its formula is as follows:

$$X = U S {V}^{T}$$

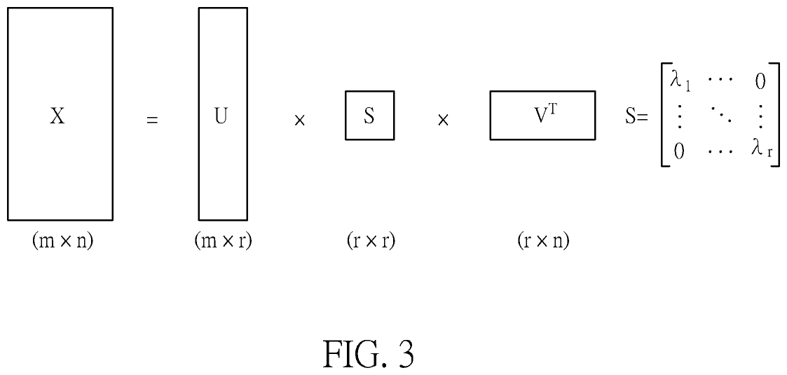

As shown in FIG. 3, X is a m×n matrix of pixel values of the aforementioned image 21, U is a m×r unitary matrix after singularly valuable decomposition, S is a r×r diagonal matrix after singularly valuable decomposition, V″ is a r×n transposed unitary matrix after singularly valuable decomposition, wherein the values in resulted matrix U and matrix V^{T} are corresponding eigenvectors, and the values λᵢ (i is between 1 and r) on the diagonal line of resulted diagonal matrix S are the eigenvalues of matrix X of pixel values, r is the rank of matrix X of pixel values, and greater value λᵣ denotes more important content and information in the image.

After the aforementioned singularly valuable decomposition is completed, defect magnification is then performed in step S3. Specific approach of this step is to multiply the result of the aforementioned singularly valuable decomposition by a coefficient K, with formula as follows:

$$K \cdot {USV}^{T} = {X}^{′}$$

wherein the coefficient K is a number of eigenvalues between 0 and 1 multiplied by a number of nonzero eigenvalues in the diagonal matrix S of the result of the aforementioned singularly valuable decomposition.

Through the aforementioned action of defect magnification, all of the pixel values of former low-rank part denoting normal semiconductor patterns in the matrix of pixel values of image 21 will become greater than a preset value, ex. greater than a maximum grayscale value 255 in 256 shades of grayscale setting, which will render a pure white color in grayscale image, while the pixel values of sparse part denoting abnormal wafer defects in the matrix of pixel value of image 21 will become less than the preset value, which will render a black color in grayscale image. The defect parts in wafer image may be therefore magnified through this action. Image 22 in FIG. 4 is exactly the wafer image obtained by processing the image 21 with the aforementioned action of defect magnification. It can be seen in the figure that the former low-rank part visually denoting normal semiconductor patterns in image 21 is filtered out, only the sparse part of wafer detects are remained. In this way, the separation of low-rank semiconductor patterns and sparse defect patterns is completed, as shown in FIG. 2.

After the aforementioned action of defect magnification, action of reconstructing a defect saliency image is then performed in step S4. Specific approach of this step is to convert the aforementioned defect-magnified grayscale image into binary image, for example, by setting all of the pixel values greater than 255 as maximum grayscale value 1 and setting all of the pixel values less than 255 as minimum grayscale value 0, thereby binarizing the wafer image. The image 23 in FIG. 4 is the wafer image obtained by processing the image 22 with the aforementioned action of reconstructing the defect saliency image. It can be seen in the figure that the former visually obscure, faint defect patterns in image 22 becomes very obvious under the background of normal semiconductor patterns, which may facilitate following action of defect detection.

After the aforementioned action of reconstructing a defect saliency image is completed, action of denoising image is then performed in step S5. Specific approach of this step is to process the aforementioned binary wafer image through closing operation, which may include dilation operation first and erosion operation later. The approach of dilation operation is to set an inputted pixel value as 1 when the pixel value of at least one of the inputted pixel and surrounding pixels is 1 with respect to the pixel value 0 of structural elements. The result of dilation operation seems to spread the image, which may fill the gaps in the image using proper structural elements. On the other hand, the approach of erosion operation is to set an inputted pixel value as 255 when the pixel value of all inputted pixel and surrounding pixels are 255 with respect to the pixel value 0 of structural elements. The result of erosion operation seems to shrink the image, which may remove unnecessary elements in the image using proper structural elements, ex. redundant background of semiconductor patterns in image 23. The image 24 in FIG. 4 is the wafer image obtained by processing the image 23 with the aforementioned closing operation. It can be seen in the figure that the former visually noise patterns and background in image 23, ex. normal semiconductor patterns, are completely removed, and only the defect patterns required in the present invention are remained in the image.

After the wafer image 24 having only the defect saliency patterns is obtained, action of defect detection is then performed in step S6. Specific approach of this step is to remove the confounding factors outside of the wafer image, such as the black background in image 24. The coordinate axis of each black spot in the defect saliency image is then acquired and spot number around each of the black spots is counted, with a counting range as shown in the square frame of image 24. If the counted spot number is greater than a preset value, the wafer image may be determined as having defects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of detecting wafer defects based on singularly valuable decomposition, comprising:
inputting a wafer image;
performing a preprocess to said wafer image through histogram equalization to obtain a preprocessed image;
performing singularly valuable decomposition to said preprocessed image;
performing defect magnification to said wafer image decomposed by said singularly valuable decomposition;
reconstructing said wafer image magnified by said defect magnification to obtain a defect saliency image;
denoising said defect saliency image; and
detecting defects in denoised said wafer image.

2. The method of detecting wafer defects based on singularly valuable decomposition of claim 1, wherein said wafer image is a matrix composed of multiple pixels, each pixel has corresponding pixel value, and said histogram equalization comprises converting said wafer image into a grayscale image and normalizing said grayscale image.

3. The method of detecting wafer defects based on singularly valuable decomposition of claim 2, wherein said pixel values are between 0 and 255 before said histogram equalization, said pixel values are between 0 and 1 after said histogram equalization and are percentage of said pixel values divided by a sum of all of said pixel values in said matrix.

4. The method of detecting wafer defects based on singularly valuable decomposition of claim 2, wherein said singularly valuable decomposition comprises dividing said wafer image into a low-rank part and a sparse part, and said low-rank part represents a background image of a wafer and said sparse part represents a defect image on said wafer.

5. The method of detecting wafer defects based on singularly valuable decomposition of claim 4, wherein said defect magnification comprises multiplying said pixel values by a coefficient, so that all of said pixel values in said background image become greater than 255 and all of said pixel values in said defect image become less than 255, thereby magnifying said defect image.

6. The method of detecting wafer defects based on singularly valuable decomposition of claim 5, wherein said singularly valuable decomposition divides m×n said matrix into three multiplied matrices, said three multiplied matrices are sequentially a m×r unitary matrix, a r×r diagonal matrix and a r×n transposed unitary matrix, wherein said coefficient is a number of eigenvalues between 0 and 1 multiplied by a number of nonzero eigenvalues in said diagonal matrix.

7. The method of detecting wafer defects based on singularly valuable decomposition of claim 1, wherein reconstructing magnified said wafer image comprises using binarization to set said pixel values greater than a preset value in magnified said wafer image as a maximum pixel value and set said pixel values less than said preset value in magnified said wafer image as a minimum pixel value, so as to obtain said defect saliency image.

8. The method of detecting wafer defects based on singularly valuable decomposition of claim 1, wherein denoising said defect saliency image comprises using closing operation to remove image noises, and said closing operation comprises dilation operation and erosion operation in order.

9. The method of detecting wafer defects based on singularly valuable decomposition of claim 1, wherein said detecting defects further comprises acquiring coordinate axis of each black spot in said defect saliency image and counting a spot number in a range around each said black spot, and said wafer image is determined as having defects if said spot number is greater than a preset value.
